(19) United States
(12) Patent Application Publication
(10) Pub. No.: US 2026/0159076 A1
(43) Pub. Date: Jun. 11, 2026

(54) LIDAR SYSTEMS FOR VEHICLES INCLUDING MULTIPLEXED POINT CLOUDS

(71) Applicant: GM GLOBAL TECHNOLOGY OPERATIONS LLC, Detroit, MI (US)

(72) Inventors: Sai Vishnu ALURU, Commerce Township, MI (US); Chao-Hung Lin, Canton, MI (US); Alison Bayzat, South Lyon, MI (US); Nadia Abousaleh, Dearborn, MI (US)

(21) Appl. No.: 18/974,267

(22) Filed: Dec. 9, 2024

(51) Int. Cl. B60W 30/09; B60W 10/04; B60W 10/18; B60W 10/20; G01S 17/89; G01S 17/931

(52) U.S. Cl. CPC B60W 30/09; B60W 10/04; B60W 10/18; B60W 10/20; G01S 17/89; G01S 17/931

(57) ABSTRACT

An example light detection and ranging (Lidar) system for a vehicle includes at least one transmitter configured to transmit Lidar signals at multiple frequencies, an omnidirectional emittable Lidar configured to transmit signals via the at least one transmitter, and multiple receivers configured to receive Lidar signals reflected from an environment around the vehicle. Each of the multiple receivers is configured to receive reflected Lidar signals at a different frequency. A vehicle control module is configured to combine frequency data from reflected Lidar signals received at the multiple receivers into a point cloud array, generate a multiplexed point cloud according to the point cloud array, supply the multiplexed point cloud to a perception stack configured to process three-dimensional imagery, and automatically control steering, acceleration and braking of the vehicle according to the multiplexed point cloud supplied to the perception stack.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to Lidar systems for vehicles, including systems using multiplexed point clouds.

Some vehicles use Lidar systems to generate images of a surrounding environment for automated vehicle control, such as autonomous driving. Lidar systems determine ranges by targeting an object or a surface with a laser and measuring the time for the reflected light to return to the receiver.

### SUMMARY

An example light detection and ranging (Lidar) system for a vehicle includes at least one transmitter configured to transmit Lidar signals at multiple frequencies, wherein the at least one transmitter is coupled with the vehicle, an omnidirectional emittable Lidar configured to transmit signals via the at least one transmitter, multiple receivers configured to receive Lidar signals reflected from an environment around the vehicle, wherein each of the multiple receivers is configured to receive reflected Lidar signals at a different frequency, and a vehicle control module configured to combine frequency data from reflected Lidar signals received at the multiple receivers into a point cloud array, generate a multiplexed point cloud according to the point cloud array, supply the multiplexed point cloud to a perception stack configured to process three-dimensional imagery, and automatically control steering, acceleration and braking of the vehicle according to the multiplexed point cloud supplied to the perception stack.

In some examples, each of the multiple receivers are coupled with the vehicle at a different location on the vehicle. In some examples, the vehicle control module is configured to index a frequency and a sweep angle for reflected Lidar signals received from each of the multiple receivers.

In some examples, the vehicle control module is configured to embed the indexed frequency and sweep angle into a point cloud. In some examples, the vehicle control module is configured to generate an array including point cloud sweep angles based on indexing the sweep angle of the point cloud, and iterate through the point cloud sweep angles to combine the frequency data into the point cloud array.

In some examples, the vehicle control module is configured to: detect at least one object in the point cloud array, index the at least one object across multiple sweep angles of the point cloud array, and track a location of the object across the multiple sweep angles of the point cloud array.

In some examples, the vehicle control module is configured to measure a point density of the point cloud array at a current index, and compare the point density to a specified point density threshold value.

In some examples, the vehicle control module is configured to supply the multiplexed point cloud to the perception stack in response to the point density being greater than the specified point density threshold value.

In some examples, the vehicle control module is configured to, in response to the point density being less than the specified point density threshold value, acquire a next sweep angle in the point cloud array and update the multiplexed point cloud according to the next sweep angle in the point cloud array.

In some examples, updating the multiplexed point cloud includes remove duplicate objects from multiplexed point cloud. In some examples, updating the multiplexed point cloud includes normalizing the point density using a specified consistent resolution, and deleting duplicate points in the multiplexed point cloud as a result of point cloud multiplexing.

In some examples, the vehicle control module is configured to track an object location in the multiplexed point cloud to determine a final object destination. In some examples, the multiplexed point cloud does not include any blind spots having a point density below a specified point density threshold value.

An example method of operating a light detection and ranging (Lidar) system for a vehicle includes transmitting, via at least one Lidar transmitter, Lidar signals at multiple frequencies, wherein the at least one Lidar transmitter is coupled with the vehicle, and a parabolic reflector is positioned to reflect the Lidar signals transmitted by the at least one Lidar transmitter, receiving, via multiple Lidar receivers, Lidar signals reflected from an environment around the vehicle, wherein each of the multiple Lidar receivers receive reflected Lidar signals at a different frequency, combining frequency data from reflected Lidar signals received at the multiple Lidar receivers into a point cloud array, generating a multiplexed point cloud according to the point cloud array, supplying the multiplexed point cloud to a perception stack configured to process three-dimensional imagery, and automatically controlling steering, acceleration and braking of the vehicle according to the multiplexed point cloud supplied to the perception stack.

In some examples, each of the multiple Lidar receivers are coupled with the vehicle at a different location on the vehicle. In some examples, the method includes indexing a frequency and a sweep angle for reflected Lidar signals received from each of the multiple Lidar receivers.

In some examples, the method includes embedding the indexed frequency and sweep angle into a point cloud. In some examples, the method includes generating an array including point cloud sweep angles based on indexing the sweep angle of the point cloud, and iterating through the point cloud sweep angles to combine the frequency data into the point cloud array.

In some examples, the method includes detecting at least one object in the point cloud array, indexing the at least one object across multiple sweep angles of the point cloud array, and tracking a location of the object across the multiple sweep angles of the point cloud array.

An example light detection and ranging (Lidar) system for a vehicle includes at least one transmitter configured to transmit Lidar signals at multiple frequencies, wherein the at least one transmitter is coupled with the vehicle, multiple receivers configured to receive Lidar signals reflected from an environment around the vehicle, wherein each of the multiple receivers is configured to receive reflected Lidar signals at a different frequency, and a vehicle control module configured to combine frequency data from reflected Lidar signals received at the multiple receivers into a point cloud array, generate a multiplexed point cloud according to the point cloud array, supply the multiplexed point cloud to a perception stack configured to process three-dimensional imagery, and automatically control steering, acceleration and braking of the vehicle according to the multiplexed point cloud supplied to the perception stack.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of an example vehicle including a Lidar system having multiple Lidar receivers, according to an example of the present disclosure.

FIG. 2 is an example block diagram of a multi-frequency Lidar transmission system for a vehicle including multiple Lidar receivers, according to an example the present disclosure.

FIG. 3 is a flowchart of an example process for controlling a Lidar system for a vehicle having multiple Lidar receivers, according to an example the present disclosure.

FIG. 4 is a flowchart of an example process for acquiring point cloud frequency information based on received signals in the process of FIG. 3, according to an example the present disclosure.

FIG. 5 is a flowchart of an example process for generating multiplexed point clouds in the process of FIG. 3, according to an example the present disclosure.

In the drawings, reference numbers may be reused to identify similar and/or identical elements.

### DETAILED DESCRIPTION

In some example embodiments, a light detection and ranging (Lidar) system for vehicles may include a multi-frequency Lidar transmitter, and multiple Lidar receivers configured to receive reflected Lidar signals at different frequencies. Some Lidar technology faces limitations in generating a complete and gap-free point cloud, due to the presence of objects. In some example embodiments described herein, a Lidar system using a multiplexed point cloud may optimize and remove these shadows (e.g., blind spots where point cloud data is not obtained or is not obtained at a high enough point density to detect objects).

For example, the usage of multiplexing multiple frequency point clouds may be completed using a single Lidar system or single Lidar transmitter, with multiple receiver modules. The Lidar system may capture data from different frequencies and angles, allowing for a more comprehensive and accurate representation of the environment around the vehicle.

Example point cloud multiplexing techniques described herein may enable a Lidar system to gather data from various perspectives, thereby reducing or minimizing the impact of shadows and gaps in the point cloud data caused by objects. By effectively combining information from multiple frequency point clouds and utilizing multiple Lidar receiver modules, the resulting multiplexed point cloud can provide a more complete and detailed representation of the surroundings of the vehicle.

In some examples, a vehicle Lidar system architecture incorporates multiple wavelengths and utilizes multiplexing techniques for reduction or elimination of object shadows, to generate a point cloud with few or zero blind spots. This may be achieved by separating the Lidar signal transmit and receive functions into a standalone transmit unit, and multiple receivers at different location on the vehicle. This design may facilitate generation of a coherent full three-dimensional (3D) image from the point cloud data

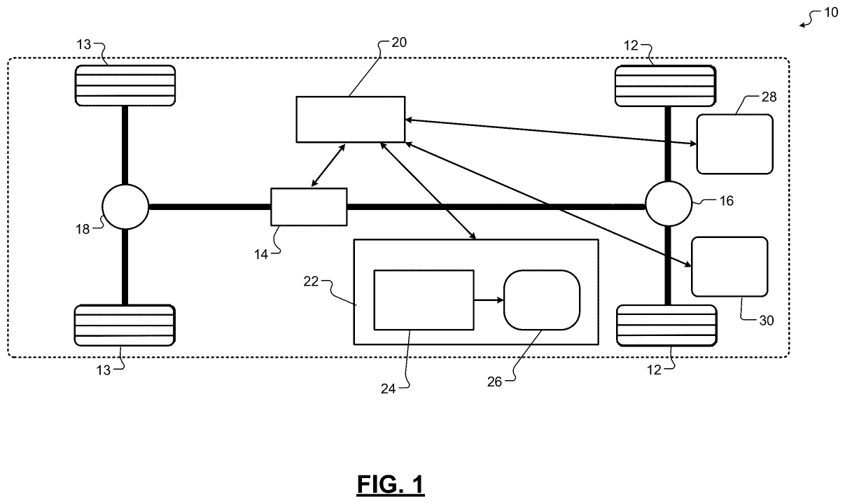

Referring now to FIG. 1, a vehicle 10 includes wheels 12 and wheels 13, which may change between front and rear wheels depending on a direction of movement of the vehicle 10 (e.g., driverless vehicles may not have a defined front side). In FIG. 1, a drive unit 14 selectively outputs torque to the wheels 12 and/or the wheels 13 via drive lines 16, 18, respectively. The vehicle 10 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 14 may include any suitable electric motor, a power inverter, and a motor controller configured to control power switches within the power inverter to adjust the motor speed and torque during propulsion and/or regeneration. A battery system provides power to or receives power from the electric motor of the drive unit 14 via the power inverter during propulsion or regeneration.

While the vehicle 10 includes one drive unit 14 in FIG. 1, the vehicle 10 may have other configurations. For example, two separate drive units may drive the wheels 12 and the wheels 13, one or more individual drive units may drive individual wheels, etc. As can be appreciated, other vehicle configurations and/or drive units can be used.

The vehicle control module 20 may be configured to control the operation of one or more vehicle components, such as the drive unit 14 (e.g., by commanding torque settings of an electric motor of the drive unit 14). The vehicle control module 20 may receive inputs for controlling components of the vehicle, such as signals received from a steering wheel, an acceleration paddle, etc. The vehicle control module 20 may monitor telematics of the vehicle for safety purposes, such as vehicle speed, vehicle location, vehicle braking and acceleration, etc.

The vehicle control module 20 may receive signals from any suitable components for monitoring one or more aspects of the vehicle, including one or more vehicle sensors (such as cameras, Lidar transmitters and Lidar receivers, microphones, pressure sensors, wheel position sensors, location sensors such as global positioning system (GPS) antennas, etc.). Some sensors may be configured to monitor current motion of the vehicle, acceleration of the vehicle, steering wheel position, etc.

As shown in FIG. 1, the vehicle 10 includes a Lidar system 22 including a multiple frequency transmitter 24 and a parabolic reflector 26. The multiple frequency transmitter may be configured to transmit Lidar signals at multiple frequencies, for example, to determine ranges by targeting objects or surface around the vehicle with a laser and measuring the time for the reflected light to return to a receiver. Example frequencies may include, but are not limited to, 10 Hz, 100 Hz, nm wavelength signals, etc. The multiple frequency transmitter 24 may be configured to change sweep angles for different signals or different frequencies of signals.

The vehicle 10 includes a first Lidar receiver 28 and a second Lidar receiver 30, each configured to receive reflected Lidar signals which are transmitted by the multiple frequency transmitter 24 and reflected off of objects or surfaces in an environment around the vehicle. In some examples, each Lidar receiver may be configured to receive a different frequency of reflected Lidar signals, and may be positioned at different locations on the vehicle 10 (e.g., the Lidar receivers may be decoupled from the multiple frequency transmitter 24). The vehicle control module 20 may store a position and/or distance of each Lidar receiver relative to the multiple frequency transmitter 24, to triangulate reflected signals received by each Lidar receiver. The Lidar signals may be transmitted in fixed directions, or may scan multiple directions around the vehicle 10.

An optional parabolic reflector 26 may reflect signals transmitted by the multiple frequency transmitter 24, to increase a number of angles or a range of the signals to provide greater coverage of an area around the vehicle 10. The parabolic reflector 26 may have any suitable shape for dispersing the reflection of transmitted signals, such as a donut shaped mirror, a parabolic ball, an inverted mushroom to provide a 360 degree view, etc. The parabolic reflector 26 may cover other sensors under the parabolic reflector 26. Although FIG. 1 illustrates one Lidar transmitter and two Lidar receivers, other example embodiments may include more transmitters and/or receivers. In some embodiments, an omnidirectionally emittable Lidar may be configured to transmit signals via at least one transmitter.

In some examples, the reflected Lidar signals received by the first Lidar receiver 28 and a second Lidar receiver 30 may be combined into a multiplexed point cloud, for 3D imaging control of vehicle functions such as automated driving. For example, multiplexed point cloud data based on Lidar signals received by the Lidar receivers may be supplied to a perception stack which automatically controls steering of the vehicle 10, acceleration of the vehicle 10 and braking of the vehicle 10, to provide an autonomous advanced driver-assistance system (ADAS).

The vehicle control module 20 may communicate with another device via a wireless communication interface, which may include one or more wireless antennas for transmitting and/or receiving wireless communication signals. For example, the wireless communication interface may communicate via any suitable wireless communication protocols, including but not limited to vehicle-to-everything (V2X) communication, Wi-Fi communication, wireless area network (WAN) communication, cellular communication, personal area network (PAN) communication, short-range wireless communication (e.g., Bluetooth), etc. The wireless communication interface may communicate with a remote computing device over one or more wireless and/or wired networks. Regarding the vehicle-to-vehicle (V2X) communication, the vehicle 10 may include one or more V2X transceivers (e.g., V2X signal transmission and/or reception antennas).

In some examples, the Lidar system may have the ability to cover shadows from objects in the lidar point cloud (due to multiplexing of point cloud data from different frequencies or sweep angles), resulting in a point cloud without blind zones. The Lidar system may capture data from all angles and perspectives, to provide a more comprehensive and accurate representation of the environment.

By integrating multiple Lidar receivers into the Lidar system, the detection range may be extended. For example, the Lidar system may detect objects that are farther away, enhancing its overall performance and capabilities. The use of multiple Lidar receivers may improve the probability of detection (PoD) of objects around the vehicle. With more Lidar receivers capturing data, the lidar system can achieve a higher level of accuracy in detecting and identifying objects in its surroundings.

In some examples, the point cloud data may be converted into an accurate image more quickly, while also increasing the resolution of the image. The Lidar system may process and analyze the data more efficiently, providing a clearer and more detailed representation of the environment.

Example Lidar systems may generate a 360-degree image using a single non-spinning lidar. This may reduce or eliminate a need for multiple sensors to cover an entire field of view, simplifying the setup and reducing costs. The integration of multiple receivers may allow for a reduction in the size of the lidar packaging. The lidar system may be more compact and lightweight, making it easier to integrate into different applications and platforms.

In some examples, the improved Lidar systems may reduce or eliminate a need for a heat sink, as the compute and energy requirements of the lidar system may be lower due to the use of a single module. This may reduce the complexity and cost of the system, while also improving its overall efficiency. Example Lidar systems may also address the issue of signal attenuation, ensuring that the Lidar system maintains a strong and reliable signal throughout its operation. This may allow the Lidar system to accurately capture and analyze data without loss or degradation in quality.

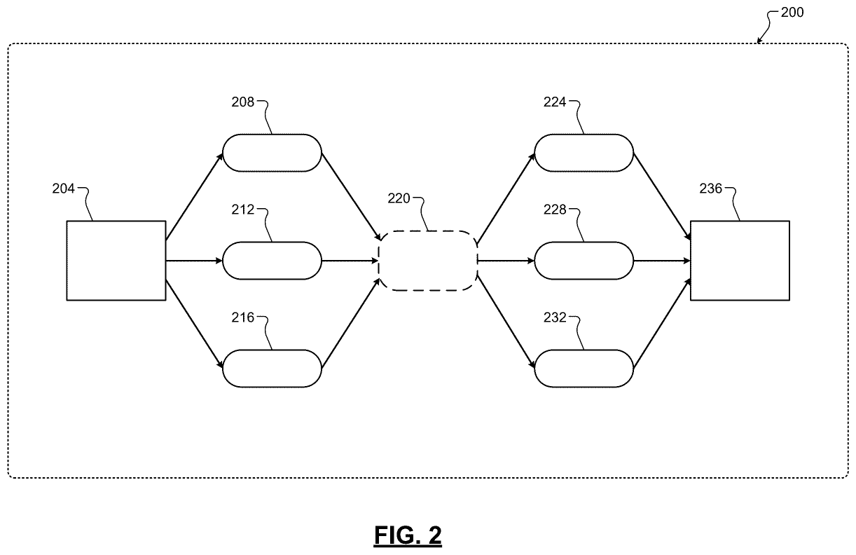

Referring now to FIG. 2, a Lidar system 200 may be a multi-frequency Lidar transmission system with multiple receivers. The Lidar system 200 of FIG. 2 may correspond to the Lidar system 22 of FIG. 1, including the first Lidar receiver 28 and the second Lidar receiver 30.

As shown in FIG. 2, a multi-frequency Lidar transmitter 204 transmits Lidar signals at multiple frequencies, such as a first frequency 208, a second frequency 212 and a third frequency 216. Although FIG. 2 illustrates three frequencies of Lidar signals, other examples may include more or less frequencies.

The different frequency signals may be reflected by an optional parabolic reflector 220, to increase an area of coverage of the signals around the vehicle. The transmitted signals are then received by multiple Lidar receivers, after reflecting off of objects or surfaces in the environment around the vehicle. FIG. 2 illustrates a first Lidar receiver 224, a second Lidar receiver 228, and a third Lidar receiver 232, which may each be configured to receive reflected signals at corresponding one of the first frequency 208, the second frequency 212 and the third frequency 216.

Other example embodiments may include more or less Lidar receivers. As explained further below, the signals received by each of the first Lidar receiver 224, the second Lidar receiver 228, and the third Lidar receiver 232, may be converted to point cloud information including indexing of frequency and sweep angle corresponding to the received signals, to generate a multiplexed point cloud.

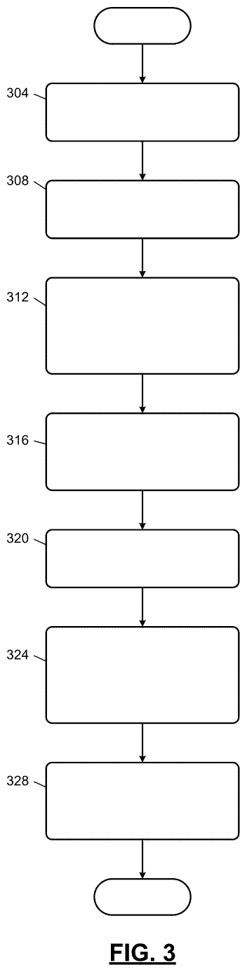

FIG. 3 is a flowchart of an example process for controlling a Lidar system for a vehicle having multiple Lidar receivers. The process of FIG. 3 may be implemented by, for example, the vehicle control module 20 of FIG. 1. At 304 the process begins by transmitting Lidar signals at multiple frequencies. For example, the multiple frequency transmitter 24 of FIG. 1 may be configured to transmit Lidar signals at different specified frequency values.

At 308, the vehicle control module is configured to reflect the transmitted Lidar signals using a parabolic reflector. For example, the multiple frequency Lidar signals transmitted by the multiple frequency transmitter 24 of FIG. 1 may be reflected by the parabolic reflector 26 of FIG. 1 to disperse the Lidar signals in a larger area or range of angles around the vehicle.

At 312, the vehicle control module is configured to receive Lidar signals reflected from the surrounding environment, at multiple decoupled Lidar receivers on the vehicle. For example, the first Lidar receiver 28 and the second Lidar receiver 30 of FIG. 1 may receive Lidar signals at different frequencies, after Lidar signals transmitted from the multiple frequency transmitter 24 and parabolic reflector 26 are reflected off of objects in an environment around the vehicle 10.

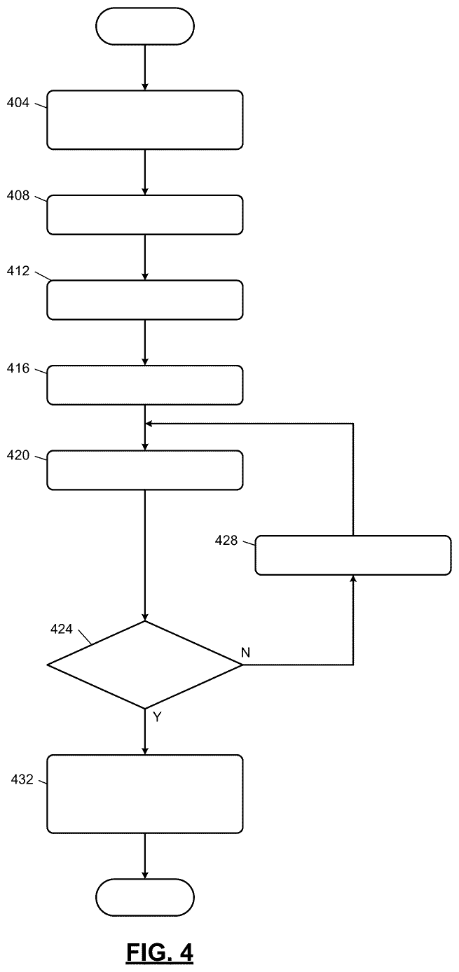

At 316, the vehicle control module is configured to acquire point cloud frequency information based on the received Lidar signals. Further details regarding acquiring the point cloud frequency information are discussed below with reference to FIG. 4.

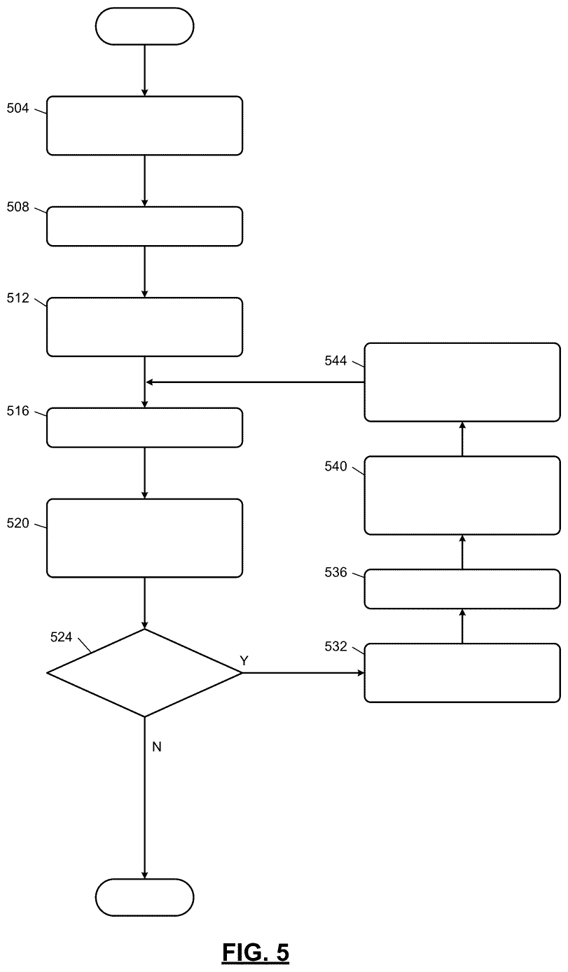

The vehicle control module is configured to generate a multiplexed point cloud at 320, which may not include blind spots (e.g., locations in 3D imagery of the multiplexed point cloud where there is not sufficient point cloud data or point density to determine whether objects are present at that location). Further details regarding generation of the multiplexed point cloud are discussed further below with reference to FIG. 5.

At 324, the vehicle control module is configured to supply three-dimensional imaging to a vehicle perception and viewing stack, based on the multiplexed point cloud. For example, the vehicle control module may be configured to generate one or more 3D images based on the multiplexed point cloud, for use by one or more vison control algorithms of the vehicle.

At 328, the vehicle control module is configured to automatically control steering, acceleration and braking of the vehicle based on the 3D imaging. For example, the multiplexed point cloud without blind spots may be used by an advanced driver-assistance system (ADAS) for automated driving control of the vehicle.

FIG. 4 is a flowchart of an example process for acquiring point cloud frequency information based on received signals in the process of FIG. 3. The process of FIG. 4 may be implemented by, for example, the vehicle control module 20 of FIG. 1. At 404 the process begins by indexing frequency and sweep angle for Lidar signals received by multiple vehicle Lidar receivers. For example, the vehicle control module may index frequency and sweep angle values corresponding to reflected Lidar signals received by the first Lidar receiver 28 and the second Lidar receiver 30 of FIG. 1.

At 408, the vehicle control module is configured to embed the frequency and sweep angle data into a point cloud. The vehicle control module then generates an array including point cloud sweep angles at 412.

At 416, the vehicle control module is configured to select a first one of 1 to N sweep angles. For example, the array may include point cloud sweep angles which are indexed from 1 to N according to different Lidar receivers, and the vehicle control module may be configured to iterate through each of the point cloud sweep angle values.

At 420, the vehicle control module is configured to combine frequency data into the point cloud array. For example, the frequency data may correspond to different Lidar signal frequencies received by different Lidar receivers each tuned to a different frequency, which may be mounted at different positions on the vehicle.

The vehicle control module is configured to determine at 424 whether a last sweep angle in the array has been reached. For example, in an array of 1 to N sweep angles, control may determine whether the Nth sweep angle has been processed.

If not, control proceeds to 428 to select a next sweep angle in the array, and then combines frequency data into the point cloud array based on the next selected sweep angle, at 420. Once the last sweep angle in the array is reached at 424, control proceeds to 432 to store the point cloud array including combined frequency data from each sweep angle.

FIG. 5 is a flowchart of an example process for generating multiplexed point clouds in the process of FIG. 3. The process of FIG. 5 may be implemented by, for example, the vehicle control module 20 of FIG. 1. At 504 the process begins by performing object recognition and detection on a point cloud which includes frequency information. For example, one or more automated object detection algorithms for Lidar point cloud image processing may be used to detect objects in the environment around the vehicle.

At 508, the vehicle control module is configured to execute object indexing. For example, each object detected in the point cloud may be assigned an index value in order to track the object across various point cloud frequency potions or sweep angles.

At 512, the vehicle control module is configured to track an object location based on the object recognition and indexing. For example, control may track a location of a specific detected object across various point cloud frequency potions or sweep angles, using an index assigned to the specific detected object.

At 516, the vehicle control module is configured to measure a point density at a current index. For example, the vehicle control module may select a first sweep angle index for the point cloud, and measure a point density at that sweep angle index. The point density may be measured using any suitable algorithm, and may be indicative of a density of points throughout the point cloud, a density of points at specific locations in the point cloud, a density of points if different sections of the point cloud, etc. The point density may be indicative of whether any blind spots exist in the point cloud where there is not sufficient data to determine the presence or lack of objects at that location.

For example, at 520 the vehicle control module is configured to determine if the measured point density is less than a specified point density threshold, which may be calibratable. The point density threshold may be set as a threshold indicative of whether any blind spots exist in the point cloud where there is not enough point data to determine a presence or lack of objects at that location.

If the measured point density is below the threshold at 524, control proceeds to 532 to acquire a next sweep angle and begin multiplexing the point cloud. For example, control may obtain point cloud data from another sweep angle, which may correspond to one or more different frequencies of reflected Lidar signals received from a different one of multiple Lidar receivers. Control may then multiplex point cloud data corresponding to the selected sweep angle with point cloud data processed for previous sweep angles.

At 536, the vehicle control module is configured to remove object duplication from the multiplexed point cloud. For example, if an object identified in a current point cloud sweep angle index is a duplicate of the same object identified in a previous point cloud sweep angle index, control may remove the object duplication data so that the same object is only identified once in the multiplexed point cloud.

At 540, the vehicle control module is configured to normalize point density using a consistent resolution in the multiplexed point cloud. For example, control may delete duplicate points resulting from multiplexing point cloud data from different sweep angle indexes, so that a consistent resolution of points is maintained as additional point cloud data is added from different sweep angle indexes.

At 544, the vehicle control module is configured to retrack object locations in the multiplexed point cloud, to determine a final object destination. For example, control may use an object index to update or confirm a location of the object in the multiplexed point cloud, after adding additional data from a different sweep angle index to the multiplexed point cloud.

Control then returns to 516 to measure a point density at the index after updating the multiplexed point cloud. Once the measured point density is above the specified point density threshold at 524, the vehicle control module is configured to transmit the multiplexed point cloud to a perception stack (e.g., for use in automated driving control or other vehicle vision systems). The multiplexed point cloud may not include any blind spots, due to the multiplexing of the point cloud data covering any blind spots that may occur in an individual one of the sweep angle indexes of point cloud data.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A light detection and ranging (Lidar) system for a vehicle, the Lidar system comprising:
at least one transmitter configured to transmit Lidar signals at multiple frequencies, wherein the at least one transmitter is coupled with the vehicle;
an omnidirectional emittable Lidar configured to transmit signals via the at least one transmitter;
multiple receivers configured to receive Lidar signals reflected from an environment around the vehicle, wherein each of the multiple receivers is configured to receive reflected Lidar signals at a different frequency; and
a vehicle control module configured to:
combine frequency data from reflected Lidar signals received at the multiple receivers into a point cloud array;
generate a multiplexed point cloud according to the point cloud array;
supply the multiplexed point cloud to a perception stack configured to process three-dimensional imagery; and
automatically control steering, acceleration and braking of the vehicle according to the multiplexed point cloud supplied to the perception stack.

2. The Lidar system of claim 1, wherein each of the multiple receivers are coupled with the vehicle at a different location on the vehicle.

3. The Lidar system of claim 1, wherein the vehicle control module is configured to index a frequency and a sweep angle for reflected Lidar signals received from each of the multiple receivers.

4. The Lidar system of claim 3, wherein the vehicle control module is configured to embed the indexed frequency and sweep angle into a point cloud.

5. The Lidar system of claim 4, wherein the vehicle control module is configured to:
generate an array including point cloud sweep angles based on indexing the sweep angle of the point cloud; and
iterate through the point cloud sweep angles to combine the frequency data into the point cloud array.

6. The Lidar system of claim 1, wherein the vehicle control module is configured to:
detect at least one object in the point cloud array;
index the at least one object across multiple sweep angles of the point cloud array; and
track a location of the object across the multiple sweep angles of the point cloud array.

7. The Lidar system of claim 6, wherein the vehicle control module is configured to:
measure a point density of the point cloud array at a current index; and
compare the point density to a specified point density threshold value.

8. The Lidar system of claim 7, wherein the vehicle control module is configured to supply the multiplexed point cloud to the perception stack in response to the point density being greater than the specified point density threshold value.

9. The Lidar system of claim 7, wherein the vehicle control module is configured to, in response to the point density being less than the specified point density threshold value, acquire a next sweep angle in the point cloud array and update the multiplexed point cloud according to the next sweep angle in the point cloud array.

10. The Lidar system of claim 9, wherein updating the multiplexed point cloud includes remove duplicate objects from multiplexed point cloud.

11. The Lidar system of claim 10, wherein updating the multiplexed point cloud includes:
normalizing the point density using a specified consistent resolution; and
deleting duplicate points in the multiplexed point cloud as a result of point cloud multiplexing.

12. The Lidar system of claim 11, wherein the vehicle control module is configured to track an object location in the multiplexed point cloud to determine a final object destination.

13. The Lidar system of claim 1, wherein the multiplexed point cloud does not include any blind spots having a point density below a specified point density threshold value 14 method.

14. A method of operating a light detection and ranging (Lidar) system for a vehicle, the method comprising:
transmitting, via at least one Lidar transmitter, Lidar signals at multiple frequencies, wherein the at least one Lidar transmitter is coupled with the vehicle, and a parabolic reflector is positioned to reflect the Lidar signals transmitted by the at least one Lidar transmitter;
receiving, via multiple Lidar receivers, Lidar signals reflected from an environment around the vehicle, wherein each of the multiple Lidar receivers receive reflected Lidar signals at a different frequency;
combining frequency data from reflected Lidar signals received at the multiple Lidar receivers into a point cloud array;
generating a multiplexed point cloud according to the point cloud array;
supplying the multiplexed point cloud to a perception stack configured to process three-dimensional imagery; and
automatically controlling steering, acceleration and braking of the vehicle according to the multiplexed point cloud supplied to the perception stack.

15. The method of claim 14, wherein each of the multiple Lidar receivers are coupled with the vehicle at a different location on the vehicle.

16. The method of claim 14, further comprising indexing a frequency and a sweep angle for reflected Lidar signals received from each of the multiple Lidar receivers.

17. The method of claim 16, further comprising embedding the indexed frequency and sweep angle into a point cloud.

18. The method of claim 17, further comprising:
generating an array including point cloud sweep angles based on indexing the sweep angle of the point cloud; and
iterating through the point cloud sweep angles to combine the frequency data into the point cloud array.

19. The method of claim 14, further comprising:
detecting at least one object in the point cloud array;
indexing the at least one object across multiple sweep angles of the point cloud array; and
tracking a location of the object across the multiple sweep angles of the point cloud array.

20. A light detection and ranging (Lidar) system for a vehicle, the Lidar system comprising:
at least one transmitter configured to transmit Lidar signals at multiple frequencies, wherein the at least one transmitter is coupled with the vehicle;
multiple receivers configured to receive Lidar signals reflected from an environment around the vehicle, wherein each of the multiple receivers is configured to receive reflected Lidar signals at a different frequency; and
a vehicle control module configured to:
combine frequency data from reflected Lidar signals received at the multiple receivers into a point cloud array;
generate a multiplexed point cloud according to the point cloud array;
supply the multiplexed point cloud to a perception stack configured to process three-dimensional imagery; and
automatically control steering, acceleration and braking of the vehicle according to the multiplexed point cloud supplied to the perception stack.
